(19) United States
(12) Patent Application Publication
(10) Pub. No.: US 2003/0090367 A1
(43) Pub. Date: May 15, 2003

(54) Indentification reader

(76) Inventors: Gary Thomas Carroll, Louisville, CO (US); Hugh Donal O'Byrne, Niwot, CO (US); James Donald Pauley, Estes Park, CO (US)

Correspondence Address: MASON, MASON & ALBRIGHT, 2306 South Eads Street, P.O. Box 2246, Arlington, VA, 22202, US

(21) Appl. No.: 10/259,750

(22) Filed: Sep. 30, 2002

Related U.S. Application Data
(63) Continuation of application No. PCT/NZ01/00279, filed on Dec. 12, 2001.
(60) Provisional application No. 60/257,201, filed on Dec. 20, 2000.

(51) Int. Cl. H04Q 5/22

(52) U.S. Cl. 340/10.4

(57) ABSTRACT

The present invention relates to an identification reader including decoding means capable of decoding signals having differing modulation means.

### TECHNICAL FIELD

This invention relates to an improved identification reader.

### BACKGROUND ART

Reference throughout this specification shall be made to the use of the present invention in relation to the radio frequency (RF) identification (ID) readers. It should be appreciated however that it may be that the principles of the present invention can be applied to other ID readers.

RFID readers are well known in the art. Typically such devices are used for things such as access control, animal feeding and animal health, inventory control, process control and/or theft/security applications.

Typically these readers are used as the following.

A device such as a transponder is usually passed through a large alternating magnetic field. Often the transponder is in the form of a card.

The transponder extracts energy from the field and reflects a return signal encoded in a predetermined way such that a unique code contained within the transponder can be detected by the reader. Generally the reader is the device which also produces the magnetic field.

A number of modulation means have been used including amplitude shift keying (ASK), frequency shift keying (FSK) and phase shift keying (PSK). As well, there are a number of formats with have various bit times and bit stream length. The formats cause a number of different modulation means which require the RFID transponders be matched to readers specifically designed for a given modulation means.

This can lead to many problems.

One problem occurs when it is desired to upgrade an existing access control or another type of system that uses different identification readers. If it is desired to add extra readers and having a different modulation means and/or formats, then the whole of the system must be overhauled, rather than added to in a modular way. It should be appreciated here that usually the change in modulation means comes about as a consequence of a customer wanting to change the format of a system—which subsequently could lead to a change in modulation means.

Also, the different modulation means ensure that the existing system and the new system cannot be readily integrated with each other. For example, there may be one modulation means for inventory control and another modulation means for access control. This will necessitate having two different ID devices (such as controllers, readers and cards) for the one physical area.

This duplication is not only expensive, but also frustrating to the users.

Duplication is also a concern with regard to having to maintain multiple stocklines of finished RFID product (reader). This can be expensive, particularly as sufficient numbers of each type would have to be maintained to satisfy customers.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is an object of the present invention to address these problems, or at least to provide the public with a useful choice.

Further aspects and advantages of the present invention will now become apparent from the following description which is given by way of example only.

### DISCLOSURE OF INVENTION

According to one aspect of the present invention there is provided an identification reader including decoding means capable of decoding signals having differing modulation means.

According to another aspect of the present invention there is provided decoding means for inclusion in identification reader wherein the decoding means is capable of decoding signals having differing modulation means.

Reference throughout this specification will be made to the identification reader as being a radio frequency identification reader and the signals as operating in the radio frequency range. This should not be seen as limiting.

The decoding means may detect any modulation means presently used or likely to be used in the future in ID systems. In preferred embodiments of the present invention the modulation means which can be decoded include ASK, FSK and PSK modulation means.

While it may be possible to combine together a number of readers each being able to decode a different modulation means, this is not practical in terms of expense, size and general ease of use.

For example, one method by which the present invention could be achieved is to analyse an incoming signal (reflected from the transponder) through multiple tuned amplifiers, determine the encoding techniques using numerous pieces of demodulating hardware, analysing for various bit rates, comparing the bit stream for various preambles, and after this decoding the data. This takes a lot of hardware, space and is expensive to achieve.

However in preferred embodiments of the present invention, similar componentry will be used to that in an existing reader with just two significant changes.

Typical transponders in the industry use the carrier signal from the reader for power and clock. Once the transponder is powered up, the clock circuit will step a counter through its memory containing the data for the device. The data will then encode the incoming signal in some fashion to send the data back to the reader. All of the readers are built specifically to power and read their unique transponders and no other.

One piece of componentry in these readers is a bandpass amplifier. Typically the band is narrow as the reader is configured to only read signals within a particular frequency range that corresponds to the modulation means it expects to receive.

Thus, according to one aspect of the present invention there is provided an identification reader which incorporates a broad spectrum bandpass filter. In one embodiment, the carrier or data frequency that the filter will pass is in the order of 150 Hz to 125 kHz. This frequency range covers the range of typical modulation means, whether they use ASK, FSK or PSK modulation. The filter may be hardware or software and may or may not be associated with an amplifier.

The amplifier has been designed to have low gain at low frequencies where there is plenty of signal strength due to the “gain” of the coil. The amplifier ideally has high gain at high frequencies where the coil is inefficient.

In typical ID readers there is a microprocessor which will decode the incoming bit stream and find the synchronisation character so that it can read the data bits and check the parity or CRC for accuracy. If the bit stream is acceptable, the microprocessor will send the data to the user computer for further analysis.

Thus, the microprocessor does not determine which type of modulation means was applied to the signal it receives, it merely matches the expected modulation means.

In preferred embodiments of the present invention there is provided an additional decoder which calculates which modulation means is being used before the microprocessor is used to find the synchronisation character within that means.

The additional decoder may be merely extra operating software in an existing microprocessor within a reader. Alternatively the decoder may be separate hardware componentry, for example an additional microprocessor.

In one embodiment, the modulation decoder/detector may work as follows.

The output of the broadband amplifier may be sent to the decoder where it simply measures the frequency of the modulation signal. If the frequency is a sub-harmonic of the carrier (usually 125 kHz), then it is probably a valid transponder.

In the table below, a way of determining which scheme is used with typical existing modulation means is given. This should not be seen as limiting as it is envisaged that other types of modulation means may be developed, which some embodiments of the present invention could decode.

| | Modulation |
|---|---|
| Frequency (f) | Means |
| f/2 | PSK |
| f/4 f/5 and f/8 | PSK FSK |
| f/5 and f/8 | FSK |
| f/8 | PSK |
| f/8 and f/10 | FSK |
| f/16 or f/32 or f/64 | ASK (raw data) |

The microprocessor or decoder simply has to decide which of these modulation means is being used and then decides if the data is Manchester, Differential Biphase, Modified Differential Biphase or straight data. Then the decoder assigns a one or zero to it and sends it onto the user's computer via any transfer protocol which can include a RS232 or RS485 Wiegand or ABA interface.

It can be seen that by utilising a decoder as above, only minimal additional componentry is required to read multiple signals having varying modulation schemes. Thus, the present invention utilises software instead of hardware to provide a compact inexpensive reader that can read signals of different modulation means. This makes it relatively easy to upgrade existing systems or integrate systems so that differing identifying devices can be used in the one physical area.

The present invention also provides the advantage of not having to run large stocklines as only one reader is required to be stocked rather than readers for the variety of multiple modulation means.

It may be possible in some embodiments of the present invention to have custom design readers with formats based on market request. For example, a customer may send in one of their existing readers with appropriate access cards. The applicant may then develop a customised format for the decoder which can read all of the modulation means supplied by the cards.

### BRIEF DESCRIPTION OF THE DRAWINGS

Further aspects of the present invention will become apparent from the following description which is given by way of example only and with reference to the accompanying drawings in which:

FIG. 1 is a general block diagram of a typical identification system, and

FIG. 2 is a general block diagram of a typical identification system that has been modified to read all of the standard tags.

FIG. 3 is a general block diagram of an identification system in accordance with the present invention.

### BEST MODES FOR CARRYING OUT THE INVENTION

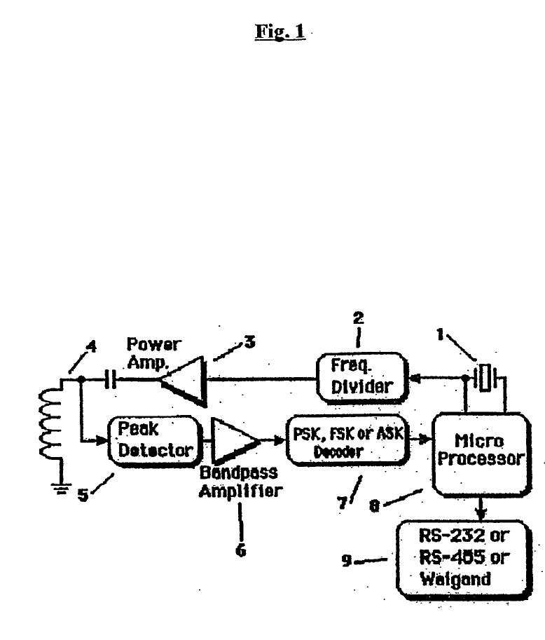

FIG. 1 shows a typical RFID reader. The crystal oscillator 1 will clock the microprocessor as well as be divided down by divider 2 to a frequency of typically 125 kHz. The crystal 1 can be any multiple of the power frequency so for this example it will be 4.00 MHz. The divider 2 will divide it by 32 to produce 125 kHz. This signal drives a high current driver 3 that will then drive the antenna coil 4. The voltage across the coil 4 is typically anywhere from 75 volts to several hundred volts peak to peak.

The peak detector 5 will do an AM detector detection of the carrier created on the coil 4. The output of the peak detector 5 is inputted to a multistage band pass amplifier 6 that will filter out the noise and amplify the small signal from the coil 4. The result of the gain and filtering of the band pass amplifier 6 is a clean signal representing the data from the transponder. This signal could be needed at the next stage. The next stage 7 is a detector appropriate to the modulation means being used. The detector will create a data bit stream to be supplied to the microprocessor 8.

The microprocessor 8 will decode the incoming bitstream and find the synchronisation character so it can read the data bits and check the parity or CRC for accuracy. If the bitstream is acceptable, the microprocessor 8 will send the data to the user's computer for further analysis via interface logic such as RS-232, RS-485 or Wiegand 9.

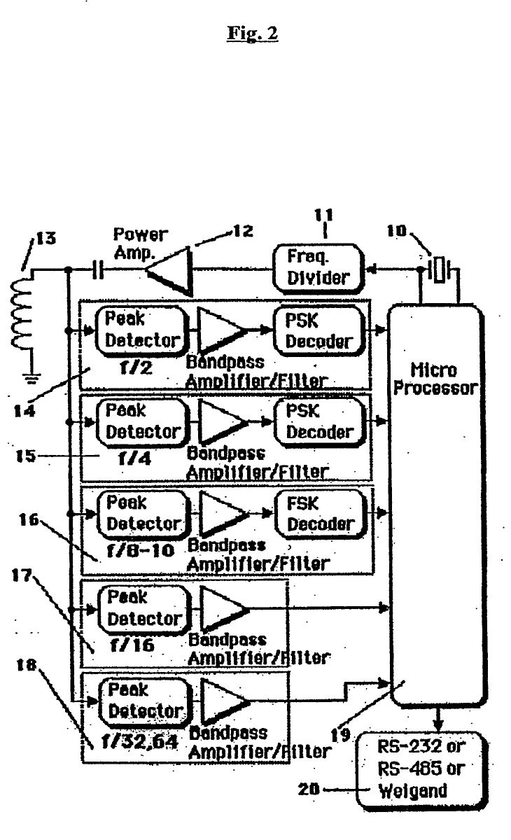

FIG. 2 depicts what a typical designer would do if a true multiple technology reader was needed. Each carrier type and data protocol would have a separate means for amplification and decoding.

The crystal oscillator 10 will clock the microprocessor as well as be divided down by 11 to a frequency of typically 125 kHz. The divider 11 in this example will divide it by 32 to create 125 kHz. This signal drives a current driver 12 that will then drive the antenna coil 13. The voltage across the coil 13 is typically anywhere from 75 volts to several hundred volts peak to peak.

Each peak detector or filter will recover the signal that is imposed upon the carrier from the coil 13 and the amplified results are then tested by the microprocessor 19. For instance, if the transponder was designed to send back PSK at the power frequency divided by 2 the first peak detector or filter/amplifier/phase detector 14 will be used to detect or filter, amplify and filter the signal while the phase detector 14 will give a different output each time the signal changes phase. This signal well be received by the microprocessor 19 and tested for sync and parity or CRC (cyclic redundancy check).

This approach is workable but clumsy and inefficient. Each type of data carrier and modulation has a separate decoding device. If the carrier is 125 kHz (f) divided by 2 (f/2) then the first channel is used 14. If the carrier is f/4 then the second channel 15 will be used. If the carrier is f/8 and 10 then the third channel 16 will be used. If the returning signal is f/16 then the output of the bandpass amplifier of the fourth channel 17 will decode data because the data is not on a carrier. Raw data is loaded on the main power and reflected back to the reader. The same is true if the returning signal if f/32 or f/64 as seen in the last channel 18.

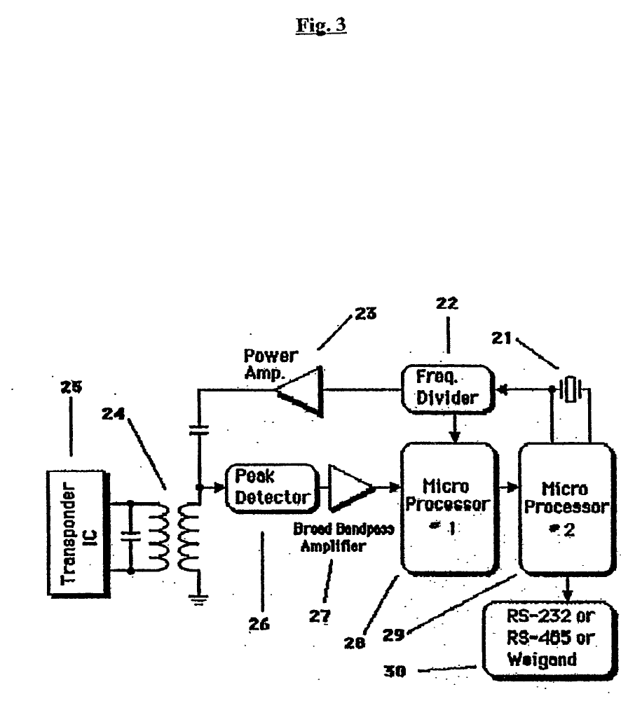

FIG. 3. shows the improvements developed for this invention. The crystal 21 will oscillate and operate the microprocessor 29 as well as be divided down by the frequency divider 22. The resulting signal drives a power amplifier 23 that in turn drives the antenna coil 24. The peak detector 26 will pick off the loading that is the result of the transponder 25 being placed in the electromagnetic field of coil 24.

The output of the peak detector 26 feeds into a broad bandpass amplifier 27 that has little gain at the lower frequencies (f/16 or more) and much more gain at the higher frequencies (up to f/2). The bandpass characteristics of this amplifier are necessary to compensate for the lower signal recovery efficiency of the antenna at higher frequencies. The result is a nearly flat response of the antenna/peak detector/amplifier combination over the frequency range from 100 Hz to 70 kHz.

This is accomplished through use of a peak detection means (Carroll, et al “Enhanced peak detector, U.S. Pat. No. 5,594,384. Jan. 14, 1997) coupled to an amplifier with special bandpass characteristics which provides an input signal to a RISC microprocessor (Carroll, et al “Electronic Identification Apparatus and Method Utilizing a Single Chip Microprocessor and an Antenna, Sep. 13, 1994) programmed to distinguish among ASK, FSK and PSK modulations. This information is provided to a second RISC microprocessor or is used by the first microprocessor to decode the signal from the tag into a bit stream that can be provided to peripheral equipment for subsequent decoding via RS232, RS485, Wiegand or ABA protocols.

Aspects of the present invention have been described by way of example only and it should be appreciated that modifications and additions may be made thereto without departing from the scope thereof as defined by the appended claims.

What we claim is:

1. An identification reader including decoding means capable of decoding signals having differing modulation means.

2. An identification reader as claimed in claim 1 which decodes signals in the radio frequency range.

3. An identification reader as claimed in claim 1 capable of decoding two or more modulation means from ASK, FSK and PSK schemes.

4. An identification reader as claimed in claim 1 which incorporates a broad spectrum bandpass filter.

5. An identification reader as claimed in claim 4 wherein the carrier or data frequency the bandpass amplifier will pass is in the order of 150 Hz to 125 kHz.

6. An identification reader as claimed in claim 4 wherein the amplifier has low gain at low frequencies and high gain at high frequencies.

7. An identification reader as claimed in claim 1 which includes a microprocessor to decode the incoming bitstream and find a synchronisation character.

8. An identification reader as claimed in claim 7 which includes a decoder which calculates which modulation means is being used before the microprocessor is used to find the synchronisation character in that modulation means.

9. An identification reader as claimed in claim 1 wherein the value of the subharmonic of the modulation signal to the carrier signal determines which modulation means is to be decoded.

10. A decoding means for use in an identification reader as claimed in claim 1.
